(19) United States
(12) Patent Application Publication
(10) Pub. No.: US 2001/0056368 A1
(43) Pub. Date: Dec. 27, 2001

(54) Ticketless system

(75) Inventor: Kosei Oguro, Tokyo (JP)

Correspondence Address: Norman P. Soloway, HAYES, SOLOWAY, HENNESSEY,, GROSSMAN & HAGE, P.C., 175 Canal Street, Manchester, NH, 03101, US

(73) Assignee: NEC Corporation

(21) Appl. No.: 09/883,704

(22) Filed: Jun. 18, 2001

(30) Foreign Application Priority Data
Jun. 19, 2000 (JP) 2000-183654

(51) Int. Cl. G06F 17/60

(52) U.S. Cl. 705/13; 705/39

(57) ABSTRACT

The network system configured of a ticket issuing center, a payment center, and an entrance gate, interconnected with a network. The system notifies the user terminal of a plurality of first data, in response to a request from a user terminal connectable to the network. Each of the plurality of first data includes a site, an admission time, and a price for admission. When receiving the second data selected among the plurality of first data, the third data, and the fourth data representing an account for payment, the system makes a payment with the fourth data. After completion of the payment, the system receives a notification of the fifth data from the user terminal connectable to the network on an admission time to the site included in the second data. Thus, when the fifth data coincides with the third data, the system permits the owner of the user terminal to pass through the entrance gate installed in the site corresponding to the site data contained in the second data.

### BACKGROUND OF THE INVENTION

The present invention relates to a ticketless system and more particularly to a ticketless system utilizing mobile terminals such as cellular telephones, mobile information terminals, and equivalents.

Recently, cellular phones and portable information terminals have been used as mobile terminals. Of mobile terminals, data communicable terminals and Internet connectable terminals are becoming increasingly common.

Moreover, on-line shopping of goods is being recently done using a network such as the Internet. A conventional ticket selling method using the on-line shopping will be described below. Here, it is assumed that a ticket to be sold is an admission permit for a concert hall or a sports stadium. The ticket specifies the date at which the ticket holder can enter the site.

First, an orderer orders a ticket through a network. At this time, the orderer specifies an address to which the ticket is sent. Next, the ordered ticket is delivered to the specified address by a delivery means such as mail or home delivery service.

FIG. 10 shows a conventional ticket selling system using a network.

A user terminal 101, a ticket issuing center terminal 102, and a credit company terminal 103 are interconnected via a network X such as the Internet.

The user terminal 101 is a mobile terminal such as a cellular phone or portable information terminal. The user terminal 101 radio-communicates with a base station (not shown) connectable to the network X, thus connecting to the network X.

The ticket issuing terminal 102 is installed in a ticket issuing center. The ticket issuing center terminal 102 has a home page provided to sell tickets.

The credit company terminal 103 is installed in a credit company which pays for tickets issued at the ticket issuing center.

Next, the conventional ticket selling method using a network will be shown below.

First, a ticket orderer accesses the home page of the ticket issuing center terminal 102, using the user terminal 11. The ticket orderer decides a desired ticket by referring to the home page and orders it on the screen (not shown) of the user terminal 101. The ticket orderer specifies the address showing a ticket receiving place on the screen of the user terminal 101.

Next, the ticket issuing center terminal 102 receiving the order of a ticket instructs the credit company terminal 103 to pay for the ticket specified by the orderer. The credit company terminal 103 previously confirms reception from the orderer in response to instruction of the payment. If there is not any problem in the received information from the orderer, the credit company 103 transmits information indicating a payable state to the ticket issuing center terminal 102.

The ticket issuing center terminal 102 receives information indicating a payable state from the credit company terminal 103 and then issues the ticket ordered by the ticket orderer. The ticket is delivered to the address specified by the orderer using a delivery means such as a mail or home delivery service.

The ticket orderer goes to the site on the date specified by the ticket. The ticket is examined when the orderer enters the site. Thus the ticket orderer can enter the site.

In the conventional ticket selling system using a network, the ordered ticket is issued to send it to the orderer. It is required for the ticket orderer to show the issued ticket at the entrance to the site.

For that reason, the system that is capable of issuing paperless tickets has been desired.

The system that can admit a ticket orderer into the site on the date specified by a ticket orderer without receiving an issued ticket has been desired.

### SUMMARY OF THE INVENTION

The present invention is made to solve the above-mentioned problems.

Another object of the present invention is to provide a ticketless system that allows a user to enter the site specified by the user on the time-of-day specified by the user, without using tickets. Another object of the present invention is to provide a method of enabling ticketless sale.

Another object of the present invention is to provide a ticketless system that can admit a ticket orderer into the site on the date specified by the ticket orderer, without receiving the issuance of a ticket.

Means for solving the above-mentioned problems are described below. Numbers and symbols inside the parentheses are attached to technical matters in Claims. Numbers and symbols clarify the coincident and corresponding relationship between technical matters in Claims and at least one of technical matters in embodiments. However, it should be noted that the technical matters in each claim are not limited to only the technical matters in embodiments.

In order to solve the above-mentioned problems, the present invention relates to a network system wherein a ticket issuing center (3), a payment center (4), and an entrance gate (5) are connected by a network (X). The ticketless system comprises first notification means for notifying the first user terminal (1) of a plurality of first data from the ticket issuing center (3), in response to a request from a first user terminal (1) connectable to the network, the plurality of first data including site data representing a site, time-of-day data representing an admission time to the site, and price data for admittance to the site; second notification means for notifying the ticket issuing center (3) of second data selected among the plurality of first data, third data for identifying the first user terminal (1), and fourth data representing an account for payment by an owner of the first user terminal (1), from the first user terminal (1); third notification means for notifying the payment center (4) of the price data included in the second data sent to the ticket issuing center (3) by the second notification means and the fourth data; payment means, in the payment center (4), for making a payment using the price data and the fourth data notified by the third notification means; fourth notification means for notifying the ticket issuing center (3) of fifth data for identifying the second user terminal (1) from the second user terminal (1) connectable to the network (X) at the site represented with the site data included in the second data on an admission time to the site represented with the time-of-day data included in the second data, after payment by the payment means; and permission means for permitting the owner of said second user terminal to pass through an entrance gate (5) installed at said site represented with said site data included in said second data when said fifth data coincides with said third data.

In the ticketless system, the fourth data comprises the number of a credit card. The payment means draws an amount of money represented with the price data included in the second data from an account shown with the credit card number.

In the ticketless system, when the fifth data coincides with the third data and a time-of-day at which the fifth data has sent to the ticket issuing center is a time-of-day represented with the time-of-day data, the permission means permits the owner of the second user terminal to pass through the entrance gate.

The ticketless system further comprises a plurality of entrance gates and setting means for setting a different gate telephone number for each of the plurality of gates. The fourth notification means issues a call to the gate telephone number corresponding to an entrance gate desired by the owner of the second user terminal after a payment of the payment means at the site represented with the site data included in the second data, using the second user terminal. A call signal included in said call includes fifth data for identifying the second user terminal. The permission means, when the fifth data coincidences with the third data, permits the owner of the second user terminal to pass through the entrance gate.

In the ticketless system, the third data comprises a telephone number of the first user terminal. The fifth data comprises a telephone number of the second user terminal.

Moreover, the present invention relates to a ticketless admission method usable in a network system wherein a ticket issuing center, a payment center, and an entrance gate are connected by a network. The ticketless admission method comprises the steps of (a) notifying the first user terminal of a plurality of first data from the ticket issuing center, in response to a request from a first user terminal connectable to the network, the plurality of first data including site data representing a site, time-of-day data representing an admission time to the site, and price data for admittance to the site; (b) notifying the ticket issuing center of second data selected among the plurality of first data, third data for identifying the first user terminal, and fourth data representing an account for payment of the owner of the first user terminal, from the first user terminal; (c) notifying the payment center of the price data included in the second data sent in the step (b) and of the fourth data; (d) making a payment with the fourth data and the price data included in the second data notified in the step (c); (e) installing the entrance gate in the site represented with the site data included in the second data; (f) notifying the ticket issuing center of fifth data for identifying the second user terminal from the second user terminal connectable to the network at the site represented with the site data included in the second data on an admission time to the site represented with the time-of-day data included in the second data, after execution of the step (d); and (g) permitting the owner of the second user terminal to pass through the entrance gate installed in the step (e) when the fifth data coincides with the third data.

In the ticketless admission system, the third data comprises a credit card number. The step (d) comprises drawing an amount of money shown with the price data notified in the step (c) from an account represented with the credit card number notified in the step (c).

In the ticketless admission system, when the fifth data coincides with the third data and the date at which the step (f) has been executed is included in a time-of-day represented with the time-of-day data, the step (g) comprises permitting the owner of the second user terminal to enter the site.

In the ticketless admission system, the step (e) further comprises the steps of (h) installing a plurality of entrance gates in the site represented with the site data included in the second data and (i) setting telephone number data representing a different telephone number to each of the entrance gates. The step (f) further comprises issuing a call to the gate telephone number set to a desired entrance gate through which the owner of the second user terminal connectable to the network passes, at the site represented with the site data included in the second data, using the second user terminal after execution of the step (d). A call signal is included in said call including fifth data to identify the user terminal. The step (g) further comprises permitting the owner of the second user terminal to pass through the entrance gate when the fifth data coincides with the fourth data.

In the ticket admission method, the third data comprises a telephone number of the first user terminal. The fifth data comprises a telephone number of the second user terminal.

Moreover, the present invention relates to a ticketless system comprising a ticket issuing center (3), a payment center (4), and an entrance gate (5), interconnected by a network (X). The ticket issuing center (3) includes first notification means for notifying a user terminal (1) of a plurality of first data in response to a request from the user terminal (1) connectable to the network (X), each of the plurality of first data including site data representing a site, time-of-day data representing a time-of-day for admittance to the site, and price data representing a price necessary for admittance to the site; second notification means for receiving a notification of second data selected among the plurality of first data, third data for identifying said user terminal (1), and fourth data representing an account for a payment by an owner of said user terminal (1), from the user terminal (1); and third notification means for notifying the payment center (4) of the price data included in the second data notified by the second notification means and the fourth data. The payment center (4) includes payment means for making a payment using the price data and the fourth data notified by the third notification means. The entrance gate (5) is installed at the site represented with the site data included in the second data prior to an admission date to the site represented with the time-of-day data included in the second data. The entrance gate includes an input section to which data can be input; input means for receiving fifth data identifying the user terminal (1) from the input section after a payment of the payment means, at the admission date to the site represented with the time-of-day data included in the second data; and permission means, when the fifth data coincides with the third data, for permitting the passage of a person which has input the fifth data.

### BRIEF DESCRIPTION OF THE DRAWINGS

This and other objects, features and advantages of the present invention will become more apparent upon a reading of the following detailed description and drawings, in which;

FIG. 1 is a diagram illustrating a ticketless system according to the present invention,

FIG. 2 is a flowchart illustrating a commodity ordering method in a ticketless system according to the present invention,

FIG. 3 is a diagram illustrating contents of various ticket data displayed on a display screen of a user terminal,

FIG. 4 is a diagram illustrating an input screen of a user terminal, which displays the card number and the expiration date of a credit card for the payment of an ordered item, and the telephone number of a user terminal carried on the admission date to a site,

FIG. 5 is a flowchart illustrating an admission method in a ticketless system, according to a first embodiment of the present invention,

FIG. 6 is a flowchart illustrating an admission method in a ticketless system, according to a second embodiment of the present invention,

FIG. 7 is a flowchart illustrating an admission method in a ticketless system, according to a third embodiment of the present invention,

FIG. 8 is a flowchart illustrating an admission method in a ticketless system, according to a forth embodiment of the present invention,

FIG. 9 is a flowchart illustrating a commodity canceling method in a ticketless system, according to the present invention,

FIG. 10 is a diagram illustrating a ticket selling system in a conventional network.

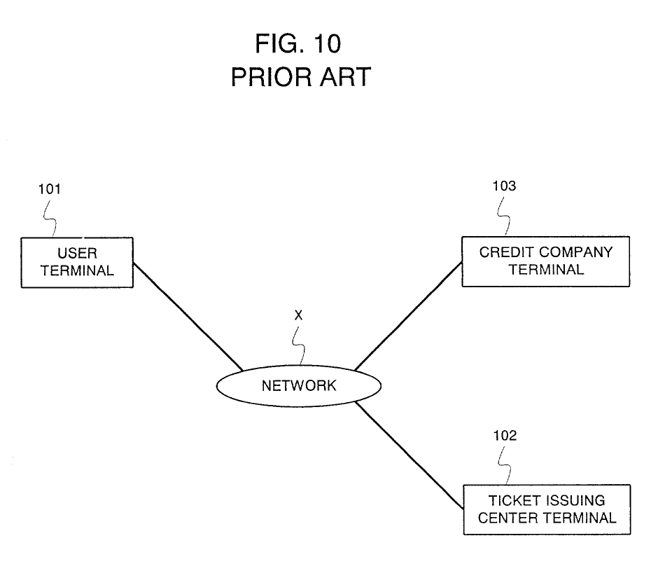

### DESCRIPTION OF THE EMBODIMENTS

A ticketless system of the present invention will be described below with reference to the attached drawings. The ticketless system is suitable for the system that admits ticket purchasers into the place that requires an admission fee and specifies the admission date, —a concert hall, a baseball or soccer stadium, a trade fair site, an exhibition hall—.

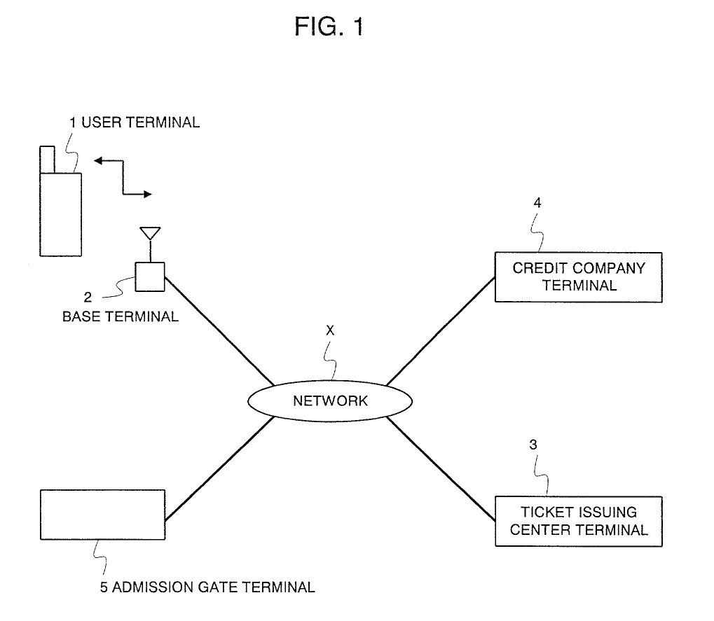

Referring to FIG. 1, the ticketless system includes a user terminal 1, a ticket issuing center terminal 3, a credit company terminal 4, and an entrance gate terminal 5, interconnected to the network X such as the Internet.

The user terminal 1 is a mobile terminal such as a cellular phone or a portable information terminal. The user terminal 1 can be connected to the network X by radio (data) communicating with the base station 2 connectable to the network X.

The ticket issuing center terminal 3 is installed in the ticket issuing center. The ticket issuing center 3 has a home page in which ticket information is registered to sell tickets. The home page places item information about various tickets via the network X. The item information relates to information about events including various sports, concert tickets, and trade fairs and includes the name of an event, the date thereof, a seat location at the site, and a price.

The credit company terminal 4 is installed in a credit company that settles the payment of a ticket issued by the ticket issuing center. Here, the location of the credit company terminal 4 is not limited to a credit company. The credit company terminal 4 may be installed in a financial institution that can settle the payment.

The entrance gate terminal 5 is installed at an entrance spot in a site such as concert halls, baseball or soccer stadiums, trade fair halls, and exhibition halls. The entrance gate terminal 5 has the shape of, for example, a station automatic ticket checker. The entrance gate terminal 5 has an entrance and an exit. Side members are placed on both sides and between the entrance and the exit. A grown-up can substantially pass through the space between the side members. An open/close gate is provided at the exit. When the gate is closed, a person cannot pass through the exit. The gate is opened or closed by the telephone number of the user terminal 1 included in a call signal from the user terminal 1.

Next, a ticketless admission method in a ticketless system according to the present invention is shown below.

First, an item ordering method in a ticketless system according to the present invention is shown below.

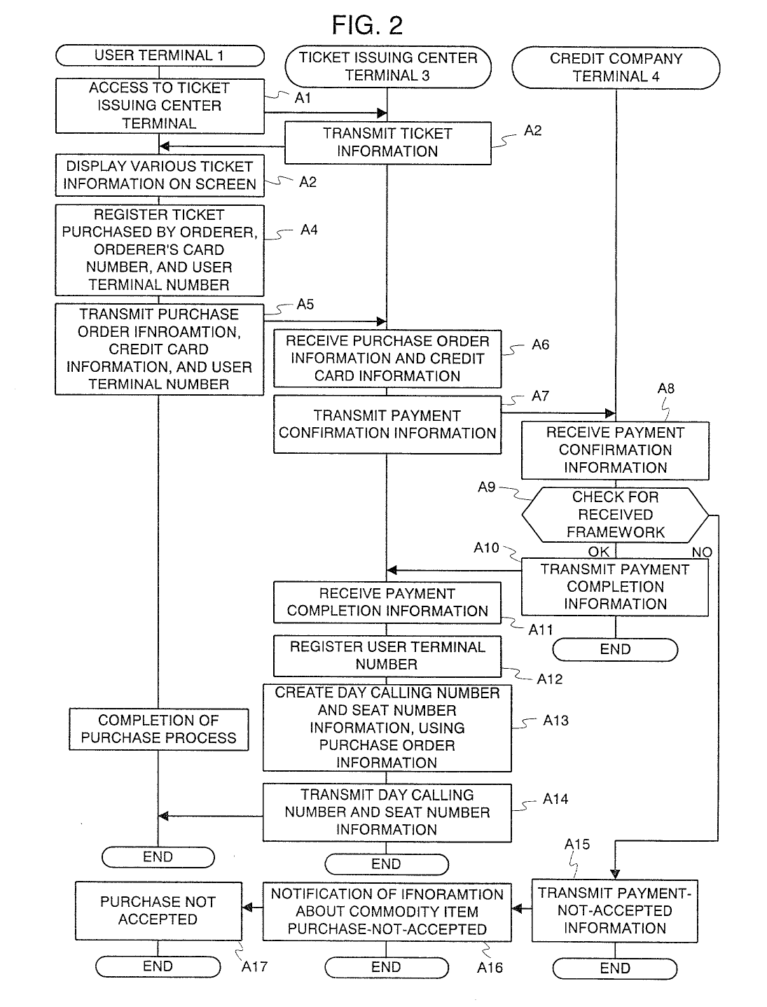

FIG. 2 is a flowchart illustrating an item ordering method in a ticketless system according to the present invention.

In the step A1 of FIG. 2, the system user uses the user terminal 1 and accesses the home page set up at the ticket issuing center terminal 3 via the network X.

In the step A2, the ticket issuing center terminal 3 transmits plural sets of ticket data to the user terminal 1. Each set of ticket data includes data showing a site such as a sports stadium and a concert hall, the admission date thereto, and the price for admission.

In the step A3, the user terminal 1 displays on the screen the content of various ticket data including a name 11, an item number 12, a price 13, and a check bar 14 representing the decision of purchase.

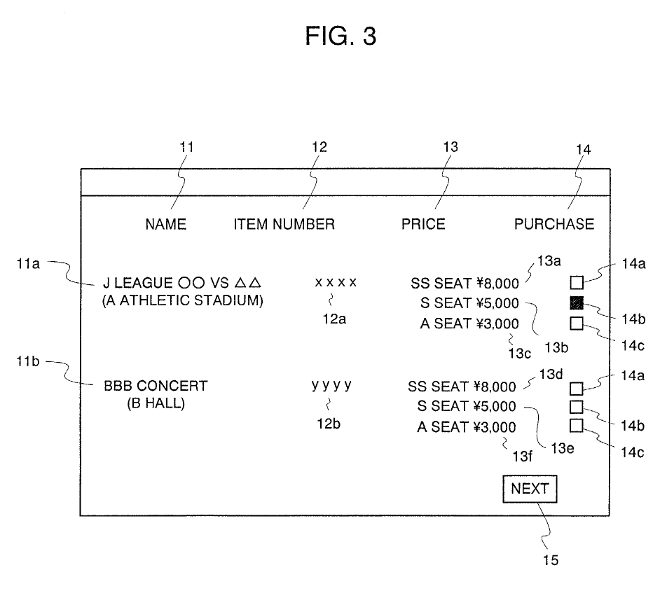

In the step A4, the system user examines the content of each set of ticket data displayed on the screen of the user terminal 1 to check the check bar 14 corresponding to a desired item on the screen. Referring to FIG. 3, the system user checks the check bar 14b to buy the item representing a name of “J league ◯◯ vs ΔΔ” (11a), an item number of “xxxx” (12a), and a price of “S seat ¥5,000” (13b). The ticket data is temporarily stored as order data into the user terminal 1.

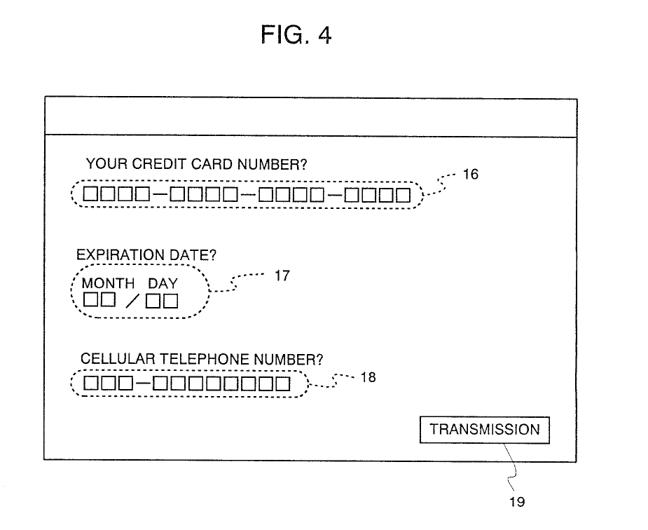

Next, the system user moves the cursor onto the “Next” button 15 on the screen shown in FIG. 3. Thus, the user terminal 1 displays the input screen as shown in FIG. 4. The input screen includes the card number 16 and the expiration date 17 of a credit card to pay the price of an ordered item, and the telephone number 18 of a user terminal carried on the admission date to the site. The system user inputs the card number 16 and the telephone number 18 on the input screen to temporarily store them into the user terminal 1

In the step A5, the system user moves the cursor onto the “transmission” bottom 19 and then clicks the transmission key. Thus, the order data, the card number 16, and the telephone number 18 stored in the user terminal 1 are transmitted to the ticket issuing center terminal 3 via the Internet X.

In the step A6, the ticket issuing center terminal 3 receives the order data, the card number 16, and the telephone number 18. In the step A7, the ticket issuing center terminal 3 creates payment confirmation information including the card number 16 and the price 13, using the order data, and then transmits the payment confirmation information to the credit company terminal 4. In the step A8, the credit card company terminal 4 receives the payment confirmation information.

In the step A9, the credit company 4 refers to receive information about an account corresponding to the card number 16 from the card number 16 included in received payment confirmation information and then checks whether or not the price 13 can be paid with the account. When it is judged that the payment can be made by the account, the credit company terminal 4 executes the step A10. When it is judged that the payment cannot be made by the account, the step A15 is executed.

In the step A10, the credit company terminal 4 pays the price 13 corresponding to the order data with the account of the card number 16. After the completion of the payment, the credit company terminal 4 transmits the payment completion information representing that payment has been completed for the item, to the ticket issuing center terminal 3.

In the step A11, the ticket issuing center terminal 3 receives the payment completion information. In the step A12, the ticket issuing center terminal 3 registers the telephone number 18 received in the step A6 in the database (not shown) connected to the ticket issuing center terminal 3.

In the step A13, the ticket issuing center terminal 3 creates a seat number captured by referring to a vacant seat database (not shown) connected to the ticket issuing center terminal 3 and a call number to be issued from the user terminal at the admission date, using the order data received in the step A6.

In the step A14, the ticket issuing center terminal 3 transmits data representing the seat number and the call number to the user terminal 1. The order of an item by the system user is completed through the above-mentioned steps.

In the step A15, the credit company terminal 4 issues payment-not-accepted information representing that the payment (settlement) of the item corresponding to the order data cannot be made with the account of the card number 16, to the ticket issuing center terminal 3.

In the step A16, in response to the payment-not-accepted information from the credit company terminal 4, the ticket issuing center terminal 3 notifies the user terminal 1 that the item cannot be purchased. At the same time, the ticket issuing center terminal 3 deletes the order data, the card number 16 and the telephone number 18 received in the step A6, from the ticket issuing center terminal 3.

In the step A17, the user terminal 1 receives a notification showing purchase-not-accepted from the ticket issuing center terminal 3. The order of the item by the system user is rejected through the operation following the step A16.

Next, the admission method in the ticketless system of the present invention will be described below.

First, the admission method in the ticketless system of the present invention according to the first embodiment of the present invention will be described below.

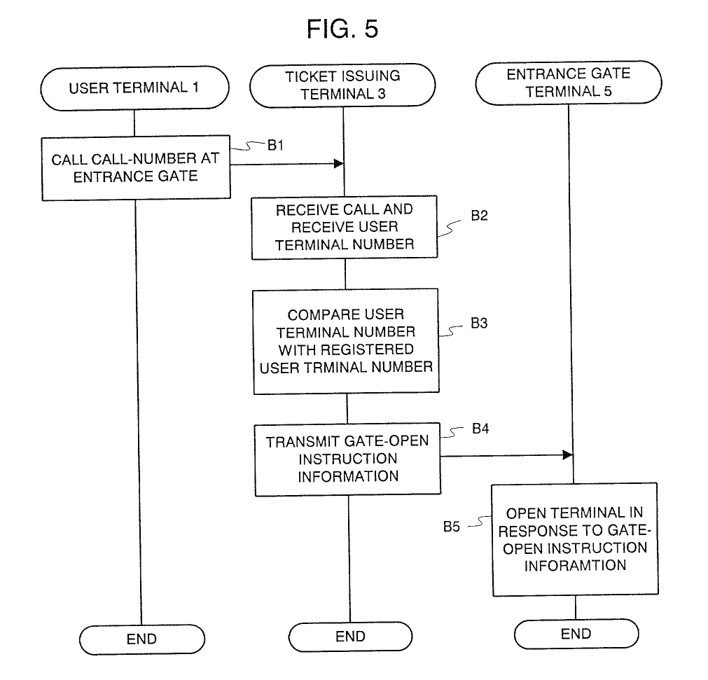

FIG. 5 is a flowchart illustrating an admission method in a ticketless system according to the first embodiment of the present invention. The ticketless item ordering method according to the embodiment is applied to the case where the system user has completely ordered items.

In the step B1 of FIG. 5, the system user goes to an entrance gate in the site on the admission date and then issues a call with a previously reported call number by means of its user terminal 1.

In the step B2, the ticket issuing center terminal 3 receives an incoming call from the user terminal 1 with the call number. The ticket issuing center terminal 3 receives the telephone number of the user terminal 1 from the call signal, in response to the incoming call.

In the step B3, the ticket issuing center terminal 3 compares the received telephone number with the telephone number 18 registered in the steps A12. When both the telephone numbers coincide with each other, the ticket issuing center terminal 3 executes the step B4. When both the telephone numbers differ from each other, the ticket issuing center terminal 3 ends its operation.

In the step B4, the ticket issuing center terminal 3 transmits gate-open instruction information to the entrance gate terminal 5.

In the step B5, the entrance gate terminal 19 opens in response to gate-open instruction information from the ticket issuing center terminal 3. This allows the system user to enter the site.

Next, the admission method in the ticketless system according to the second embodiment of the present invention will be described below.

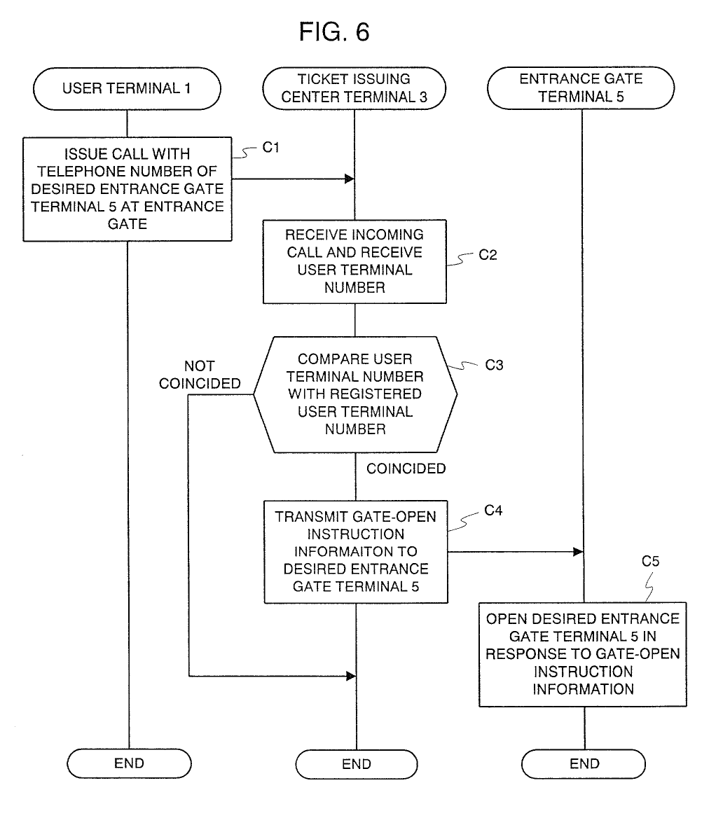

FIG. 6 is a flowchart illustrating the admission method in the ticketless system according to the second embodiment of the present invention. In this embodiment, the item ordering method in the ticketless system is applied to the case where the system user has been completely ordered.

In the admission method in the ticketless system according to the second embodiment of the present invention, the ticket issuing center terminal 3 does not create a call number in the step A13 of the item ordering method. The ticket issuing center terminal 3 does not transmit the call number to the user terminal 1 in the step A14.

Moreover, in the second embodiment, plural entrance gate terminals 5 are installed in the site. Telephone numbers are respectively allocated to the entrance gate terminals 5. Each entrance gate terminal 5 has a notice member (not shown) that notices a corresponding telephone number.

In the step C1 of FIG. 6, the system user goes to an entrance gate in the site on the admission date. Then, the system user uses its user terminal 1 and issues a call with a telephone number, which corresponds to the entrance gate terminal and is noticed on the notice member of the entrance gate terminal 5 desired by the system user.

In the step C2, the ticket issuing center terminal 3 receives an incoming call issued from the user terminal 1. In response to the incoming call, the ticket issuing center terminal 3 captures the telephone number of the user terminal 1 from the call signal.

In the step C3, the ticket issuing center terminal 3 compares the telephone number of the user terminal 1 captured from the call signal with the telephone number 18 registered in the step A12. When both the telephone numbers coincide with each other, the ticket issuing center terminal 3 executes the step C4. When both the telephone numbers differ from each other, the ticket issuing center terminal 3 ends its operation.

In the step C4, the ticket issuing center terminal 3 transmits gate-open instruction information to a desired entrance gate terminal 5.

In the step C5, the entrance gate 5 opens in response to gate-open instruction information from the ticket issuing center terminal 3. This allows the system user to enter the site through the desired entrance gate terminal 5.

In the above-mentioned embodiment, plural gate entrance terminals are respectively installed in entrance gates in the site. The system user can enter the site at the entrance gate terminal.

Next, an admission method in the ticketless system according to the third embodiment of the present invention will be described below.

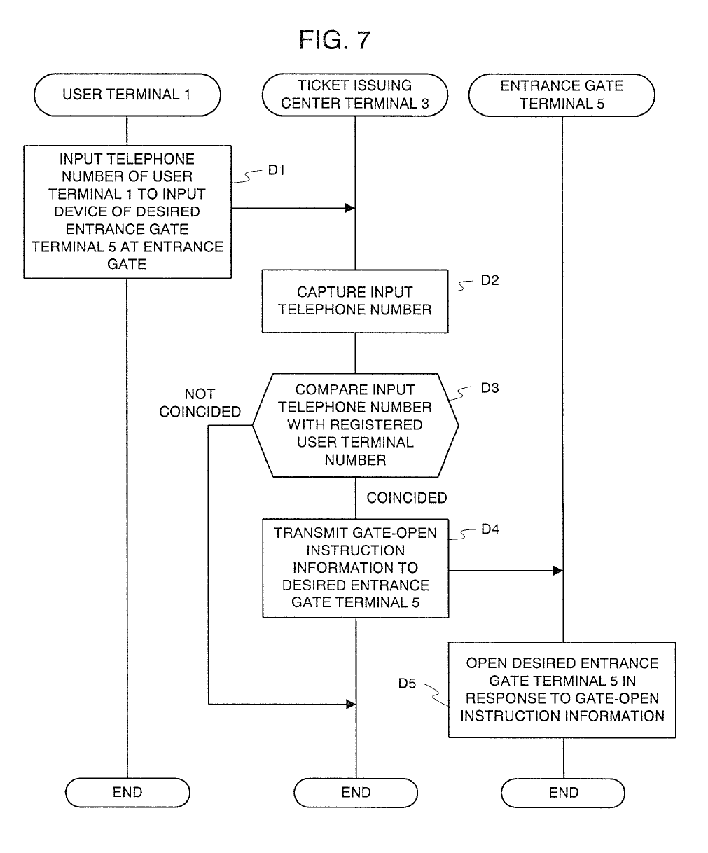

FIG. 7 is a flowchart illustrating the admission method in the ticketless system according to the third embodiment of the present invention. The embodiment is applied to the case where the system user has completely ordered in the item ordering method.

In the third embodiment, the ticket issuing center terminal 3 does not create a call number in the step A13. The ticket issuing center terminal 3 does not transmit a call number to the user terminal 1 in the step A14.

In the third embodiment, plural entrance gate terminals 5 are installed in the site. Each entrance gate terminal 5 has an input device (not shown) to input a telephone number.

In the step D1 of FIG. 7, the system user goes to an entrance gate in the site on the admission date and inputs a telephone number of the its user terminal 1 via the input device of the entrance gate terminal 5 desired by the system user.

In the step D2, the ticket issuing center terminal 3 captures a telephone number input from the input device.

In the step D3, the ticket issuing center terminal 3 compares the telephone number input from the input device with the telephone number 18 registered in the step A12. When both the telephone numbers coincide with each other, the ticket center terminal 3 executes the step D4. When both the telephone numbers differ from each other, the ticket center terminal 3 ends its operation.

In the step D4, the ticket issuing center terminal 3 transmits gate-open instruction information to the entrance gate terminal 5 to which the system user wants for entrance.

In the step D5, the entrance gate terminal 5 opens in response to the gate-open instruction information from the ticket issuing center terminal 3. This operation allows the system user to enter the site through the desired entrance gate terminal 5.

Next, an admission method in the ticketless system according to the fourth embodiment of the present invention will be described below.

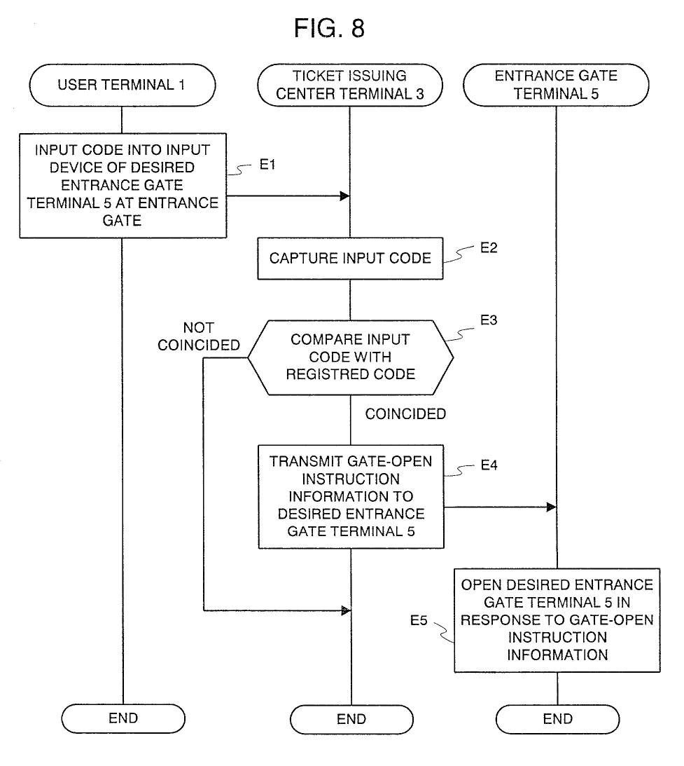

FIG. 8 is a flowchart illustrating an admission method in the ticketless system according to the fourth embodiment of the present invention. The present embodiment is applied to the case where the system user has completely ordered in the item ordering method.

In the fourth embodiment of the admission method in the ticketless system, the ticket issuing center terminal 3 does not creates a call number in the step A13. The ticket issuing center terminal 3 does not transmits a call number in the step A14 to the user terminal 1.

Moreover, in the admission method of the fourth embodiment, a code of identifying the system user is input in the step A4 of the order issuing method, in place of the inputting of the telephone number 18. The code input in the step A4 is registered in the step A12.

In the third embodiment, plural entrance gate terminals 5 are installed in the site. Input devices (not shown) for inputting codes are respectively installed in each entrance gate terminals 5.

In the step E1 of FIG. 8, the system user goes to an entrance gate on the admission date in the site. The system user inputs the code for identifying the system user to the input device of the admission gate terminal 5 desired by the system user.

In the step E2, the ticket issuing center terminal 3 captures the code input from the input device.

In the step E3, the ticket issuing center terminal 3 compares the code input from the input device with the code registered in the step A12. When both the codes coincide with each other, the ticket issuing center terminal 3 executes the step E4. When both the codes do not coincide from each other, the ticket issuing center terminal 3 ends the operation.

In the step E4, the ticket issuing center terminal 3 transmits gate-open instruction information to the entrance gate terminal 3 to which the entrance is desired.

In the step E5, the entrance gate 5 opens in response to the gate-open instruction information from the ticket issuing center terminal 3. This operation allows the system user to enter the site through the entrance gate terminal 5.

Next, the item canceling method in the ticketless system of the present invention is described below.

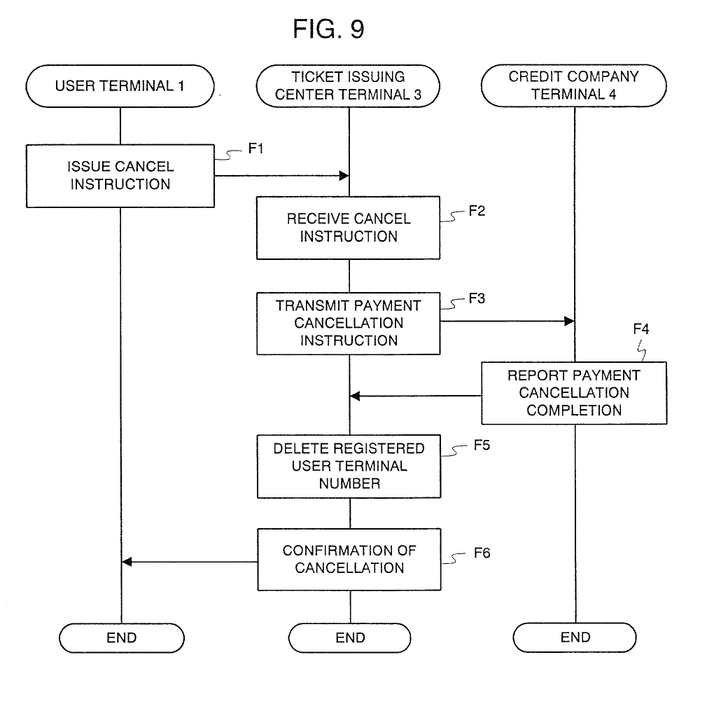

FIG. 9 is a flowchart illustrating the item canceling method in the ticketless system according to the present invention. This embodiment is applied to the case where the system user has completely ordered in the ticketless item reservation method.

In the step F1 of FIG. 9, the system user uses the user terminal 1 to transmit cancel instruction information for instructing the canceling of an item to the ticket issuing center terminal 3. The cancel instruction information includes item cancellation data representing an item to be canceled.

In the step F2, the ticket issuing center terminal 3 receives the cancel instruction information from the user terminal 1.

In the step F3, the ticket issuing center terminal 3 instructs cancellation of a settlement to the credit company terminal 4 to cancel the settlement process of a canceled item implemented to the system user in the steps A4 to A10.

In the step F4, the credit company terminal 30 cancels the settlement. After completion of the settlement, the credit company terminal 4 notifies the ticket issuing center terminal 3 of the cancel completion information representing the completion of the settlement.

In the step F5, the ticket issuing center terminal 3 deletes the terminal number of the user terminal 1 registered in the database in the step A13.

In the step F6, immediately when the ticket issuing center terminal 3 receives the cancel completion information, the ticket issuing center terminal 3 transmits information representing confirmation of cancellation to the user terminal 1. Through the above-mentioned process, the system user completes cancellation of an item.

In the ticketless system of the present invention described above, the system user, which carries a cellular phone connectable to the Internet, can enter a desired site without carrying the ticket. The reason is that the ticketless system uses transmitting the telephone number, or ID number, inherent to a cellular phone, at the time of calling.

In the ticketless system, the ticket issuing center implements the exchange of an item and the payment of a price through the Internet so that issuing of paper tickets is eliminated.

Moreover, the ticketless system eliminates the manpower to confirm the entrance to the site, thus realizing reduction of expenses (personnel expenses).

The present invention has the advantage of allowing the user to enter the site specified by the user on the date specified by a user, without using a ticket.

Moreover, the present invention has the advantage of executing the exchange of an item and the payment for a price on the Internet so that it is unnecessary to issue paper tickets.

Moreover, the present invention has the advantage of eliminating manpower for confirmation of the entrance to a site, thus reducing expenses (personnel expenses).

What is claimed is:

1. A ticketless system including a network system wherein a ticket issuing center, a payment center, and an entrance gate are connected by a network, said ticketless system comprising:
first notification means for notifying said first user terminal of a plurality of first data from said ticket issuing center, in response to a request from a first user terminal connectable to said network, said plurality of first data including site data representing a site, time-of-day data representing an admission time to said site, and price data for admittance to said site;
second notification means for notifying said ticket issuing center of second data selected among said plurality of first data, third data for identifying said first user terminal, and fourth data representing an account for payment by an owner of said first user terminal, from said first user terminal;
third notification means for notifying said payment center of said price data included in said second data sent to said ticket issuing center by said second notification means and said fourth data;
payment means, in said payment center, for making a payment using said price data and said fourth data notified by said third notification means;
fourth notification means for notifying said ticket issuing center of fifth data for identifying said second user terminal from said second user terminal connectable to said network at the site represented with said site data included in said second data on an admission time to said site represented with said time-of-day data included in said second data, after payment by said payment means; and
permission means for permitting the owner of said second user terminal to pass through an entrance gate installed at said site represented with said site data included in said second data when said fifth data coincides with said third data.

2. The ticketless system defined in claim 1, wherein said fourth data comprises the number of a credit card; and wherein said payment means draws an amount of money represented with said price data included in said second data from an account shown with said credit card number.

3. The ticketless system defined in claim 1, wherein when said fifth data coincides with said third data and a time-of-day at which said fifth data has sent to said ticket issuing center is a time-of-day represented with said time-of-day data, said permission means permits the owner of said second user terminal to pass through said entrance gate.

4. The ticketless system defined in claim 1, further comprising a plurality of entrance gates and setting means for setting a different gate telephone number for each of said plurality of gates; and
wherein said fourth notification means issues a call to said gate telephone number corresponding to an entrance gate desired by said owner of said second user terminal after a payment of said payment means at said site represented with said site data included in said second data, using said second user terminal, a call signal included in said call including fifth data for identifying said second user terminal;
wherein said permission means, when said fifth data coincidences with said third data, permits said owner of said second user terminal to pass through said entrance gate.

5. The ticketless system defined in claim 1, wherein
said third data comprises a telephone number of said first user terminal; and
said fifth data comprises a telephone number of said second user terminal.

6. A ticketless admission method in a network system wherein a ticket issuing center, a payment center, and an entrance gate are connected by a network, said ticketless admission method comprising the steps of:
(a) notifying said first user terminal of a plurality of first data from said ticket issuing center, in response to a request from a first user terminal connectable to said network, said plurality of first data including site data representing a site, time-of-day data representing an admission time to said site, and price data for admittance to said site;
(b) notifying said ticket issuing center of second data selected among said plurality of first data, third data for identifying said first user terminal, and fourth data representing an account for payment of said owner of said first user terminal, from said first user terminal;
(c) notifying said payment center of said price data included in said second data sent in said step (b) and of said fourth data;
(d) making a payment with said fourth data and said price data included in said second data notified in said step (c);
(e) installing said entrance gate in said site represented with said site data included in said second data;
(f) notifying said ticket issuing center of fifth data for identifying said second user terminal from said second user terminal connectable to said network at the site represented with said site data included in said second data on an admission time to said site represented with said time-of-day data included in said second data, after execution of said step (d); and
(g) permitting said owner of said second user terminal to pass through said entrance gate installed in said step (e) when said fifth data coincides with said third data.

7. A ticketless admission system defined in claim 6, wherein said third data comprises a credit card number and wherein said step (d) comprises drawing an amount of money shown with said price data notified in said step (c) from an account represented with said credit card number notified in said step (c).

8. The ticket admission method defined in claim 6, wherein said step (g) comprises permitting said owner of said second user terminal to enter said site when said fifth data coincides with said third data and the date at which said step (f) has been executed is included in a time-of-day represented with said time-of-day data.

9. The ticketless admission method defined in claim 6, wherein
said step (e) further comprises the steps of (h) installing a plurality of entrance gates in said site represented with said site data included in said second data and (i) setting telephone number data representing a different telephone number to each of said entrance gates;
said step (f) further comprises issuing a call to said gate telephone number set to a desired entrance gate through which the owner of said second user terminal connectable to said network passes, at said site represented with said site data included in said second data, using said second user terminal after execution of said step (d), a call signal included in said call including fifth data to identify said user terminal;
said step (g) further comprises permitting said owner of said second user terminal to pass through said entrance gate when said fifth data coincides with said fourth data.

10. The ticketless admission method defined in claim 6, wherein
said third data comprises a telephone number of said first user terminal; and
said fifth data comprises a telephone number of said second user terminal.

11. A ticketless system comprising a ticket issuing center, a payment center, and an entrance gate, interconnected by a network,
said ticket issuing center including:
first notification means for notifying a user terminal of a plurality of first data in response to a request from said user terminal connectable to said network, each of said plurality of first data including site data representing a site, time-of-day data representing a time-of-day for admittance to said site, and price data representing a price necessary for admittance to said site;
second notification means for receiving a notification of second data selected among said plurality of first data, third data for identifying said user terminal, and fourth data representing an account for a payment by an owner of said user terminal, from said user terminal; and
third notification means for notifying said payment center of said price data included in said second data notified by said second notification means and said fourth data;
said payment center including:
payment means for making a payment using said price data and said fourth data notified by said third notification means;
said entrance gate installed at said site represented with said site data included in said second data prior to an admission date to said site represented with said time-of-day data included in said second data, said entrance gate including:
an input section to which data can be input;
input means for receiving fifth data identifying said user terminal from said input section after a payment of said payment means, at the admission date to said site represented with said time-of-day data included in said second data; and
permission means, when said fifth data coincides with said third data, for permitting the passage of a person which has input said fifth data.

12. The ticketless system defined in claim 11, wherein said fourth data comprises the number of a credit card; and wherein said payment means draws an amount of money represented with said price data included in said second data from an account shown with said credit card number.

13. The ticketless system defined in claim 11, wherein when said fifth data coincides with said third data and a time-of-day at which said fifth data has sent to said ticket issuing center is a time-of-day represented with said time-of-day data, said permission means permits the owner of said second user terminal to pass through said entrance gate.

14. The ticketless system defined in claim 11, further comprising a plurality of entrance gates and setting means for setting a different gate telephone number for each of said plurality of gates; and
wherein said fourth notification means issues a call to said gate telephone number corresponding to an entrance gate desired by said owner of said second user terminal after a payment of said payment means at said site represented with said site data included in said second data, using said second user terminal, a call signal included in said call including fifth data for identifying said second user terminal;
wherein said permission means, when said fifth data coincidences with said third data, permits said owner of said second user terminal to pass through said entrance gate.

15. The ticketless system defined in claim 11, wherein
said third data comprises a telephone number of said first user terminal; and
said fifth data comprises a telephone number of said second user terminal.
